(19) United States
(12) Patent Application Publication
(10) Pub. No.: US 2025/0242300 A1
(43) Pub. Date: Jul. 31, 2025

(54) CARBON DIOXIDE IMMOBILIZATION SYSTEM AND CARBON DIOXIDE IMMOBILIZATION METHOD

(71) Applicant: TOYOTA JIDOSHA KABUSHIKI KAISHA, Toyota-shi (JP)

(72) Inventors: Yoshiteru YAZAWA, Nagoya-shi (JP); Akira KATO, Toyota-shi (JP); Koseki SUGIYAMA, Sunto-gun (JP); Masahiko TAKEUCHI, Toyota-shi (JP); Yuki TAKAHASHI, Miyoshi-shi (JP)

(73) Assignee: TOYOTA JIDOSHA KABUSHIKI KAISHA, Toyota-shi (JP)

(21) Appl. No.: 18/986,920

(22) Filed: Dec. 19, 2024

(30) Foreign Application Priority Data
Jan. 26, 2024 (JP) 2024-010536

(51) Int. Cl. B01D 53/22; B01D 53/30; B01D 53/62; B01D 53/77; B01D 53/82

(52) U.S. Cl. CPC B01D 53/229; B01D 53/226; B01D 53/30; B01D 53/62; B01D 53/77; B01D 53/82; B01D 2251/404; B01D 2257/504

(57) ABSTRACT

A CO₂ immobilization system includes: a CO₂ capture apparatus configured to separate, using a separation membrane module that selectively allows CO₂ to permeate therethrough, from a first gas a second gas containing a higher concentration of CO₂ than the first gas does and extract the separated second gas; a carbonate generation apparatus configured to cause CO₂ in the second gas extracted from the CO₂ capture apparatus to be reacted with an alkaline earth compound to generate carbonate; and a sensor configured to detect a concentration of CO₂ in the second gas. In the CO₂ capture apparatus, a plurality of the separation membrane modules are provided so as to be connected to each other in multiple stages, and the number of connection stages of the separation membrane modules is switched in such a way that the concentration of CO₂ detected by the sensor is maintained within a predetermined target concentration range.

### CROSS REFERENCE TO RELATED APPLICATIONS

This application is based upon and claims the benefit of priority from Japanese patent application No. 2024-010536, filed on Jan. 26, 2024, the disclosure of which is incorporated herein in its entirety by reference.

### BACKGROUND

The present disclosure relates to a carbon dioxide immobilization system and a carbon dioxide immobilization method.

As a technology for reducing carbon dioxide (hereinafter also referred to as CO₂), a Direct Air Capture (DAC) that directly captures CO₂ in the atmosphere is known. Patent Literature 1 discloses a DAC that uses a chemical absorption method for capturing CO₂ in the atmosphere by causing an absorption liquid to absorb CO₂.

The captured CO₂ is immobilized by, for example, reacting it with alkaline earth compounds to generate carbonate.
Patent Literature 1: Japanese Unexamined Patent Application Publication No. 2023-131882

### SUMMARY

It is known that, in the chemical absorption method disclosed in Patent Literature 1 and so on, a large amount of energy is required to extract CO₂ from an absorption liquid that has absorbed CO₂.

The inventors have examined a membrane separation method which has a higher energy efficiency than that of the chemical absorption method. In the membrane separation method, a separation membrane that selectively causes CO₂ in a gas to permeate therethrough is used to extract gas containing a higher concentration of CO₂.

However, if the concentration of CO₂ in the gas extracted by the membrane separation method is too low, when carbonate is generated and CO₂ is immobilized, a reaction time increases. On the other hand, if the concentration of CO₂ in the extracted gas is too high, when carbonate is generated and CO₂ is immobilized, it is possible that excessive CO₂ that does not react with alkaline earth compounds may be released into the atmosphere again.

The present disclosure has been made in view of the aforementioned circumstances, and provides a carbon dioxide immobilization system capable of preventing the causing of an excessive amount of carbon dioxide while reducing the reaction time when carbonate is generated and carbon dioxide is immobilized.

A carbon dioxide immobilization system according to the present disclosure includes: a carbon dioxide capture apparatus configured to separate, using a separation membrane module that selectively allows carbon dioxide to permeate therethrough, from a first gas a second gas containing a higher concentration of carbon dioxide than the first gas does and extract the separated second gas; a carbonate generation apparatus configured to cause carbon dioxide in the second gas extracted from the carbon dioxide capture apparatus to be reacted with an alkaline earth compound to generate carbonate; and a sensor configured to detect a concentration of carbon dioxide in the second gas, in which in the carbon dioxide capture apparatus, a plurality of the separation membrane modules are provided so as to be connected to each other in multiple stages, and the number of connection stages of the separation membrane modules is switched in such a way that the concentration of carbon dioxide detected by the sensor is maintained within a predetermined target concentration range.

A carbon dioxide immobilization method according to the present disclosure includes: separating, using a separation membrane module that selectively allows carbon dioxide to permeate therethrough, from a first gas a second gas containing a higher concentration of carbon dioxide than the first gas does and extracting the separated second gas; and causing carbon dioxide in the extracted second gas to be reacted with an alkaline earth compound to generate carbonate, in which in the separation and extraction of the second gas, a concentration of carbon dioxide in the extracted second gas is detected, and the number of connection stages of the plurality of the separation membrane modules provided so as to be connected to each other in multiple stages is switched in such a way that the detected concentration of carbon dioxide is maintained within a predetermined target concentration range.

In one aspect according to the present disclosure, the concentration of carbon dioxide in the extracted second gas is detected, and the number of connection stages of a plurality of separation membrane modules provided in such a way that they can be connected to each other in multiple stages is switched in such a way that the detected concentration of carbon dioxide is maintained within a predetermined target concentration range. Therefore, when carbonate is generated and carbon dioxide is immobilized, the concentration of carbon dioxide in the second gas can be maintained within a predetermined target concentration range, and it is thus possible to prevent the causing of an excessive amount of carbon dioxide while reducing the reaction time.

When the detected concentration of carbon dioxide is lower than the predetermined target concentration range, the number of connection stages of the separation membrane modules may be increased, and when the detected concentration of carbon dioxide is higher than the predetermined target concentration range, the number of connection stages of the separation membrane modules may be decreased.

Further, the alkaline earth compound may be included in incinerated ash, slag, or seawater.

According to the present disclosure, it is possible to provide a carbon dioxide immobilization system capable of preventing the causing of an excessive amount of carbon dioxide while reducing the reaction time when carbonate is generated and carbon dioxide is immobilized.

The above and other objects, features and advantages of the present disclosure will become more fully understood from the detailed description given hereinbelow and the accompanying drawings.

### BRIEF DESCRIPTION OF DRAWINGS

FIG. 1 is a block diagram showing a configuration of a carbon dioxide immobilization system according to a first embodiment;

FIG. 2 is a block diagram showing a detailed configuration of one example of a CO₂ capture apparatus 100;

FIG. 3 is a flowchart showing a carbon dioxide immobilization method according to the first embodiment; and

FIG. 4 is a flowchart showing a CO₂ concentration control method in a second gas in Step ST1 in FIG. 3.

### DESCRIPTION OF EMBODIMENTS

Hereinafter, with reference to the drawings, specific embodiments of the present disclosure will be described in detail. However, the present disclosure is not limited to the following embodiments. Further, for the sake of clarification of the description, the following descriptions and the drawings are simplified as appropriate.

### First Embodiment

### <Configuration of Carbon Dioxide Immobilization System>

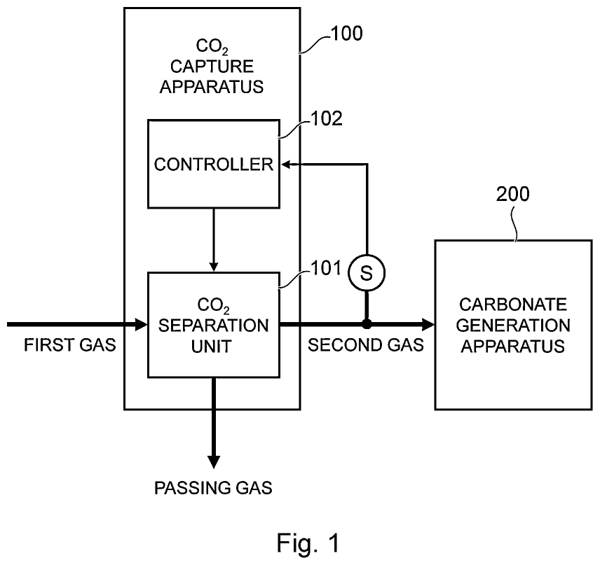

First, with reference to FIG. 1, a configuration of a carbon dioxide immobilization system according to a first embodiment will be described. FIG. 1 is a block diagram showing a configuration of the carbon dioxide immobilization system according to the first embodiment. In FIG. 1, thick arrows indicate a flow of gas and thin arrows indicate a flow of a signal.

As shown in FIG. 1, the carbon dioxide immobilization system according to this embodiment includes a CO₂ capture apparatus 100, a carbonate generation apparatus 200, and a sensor S. The CO₂ capture apparatus 100 includes a CO₂ separation unit 101 and a controller 102.

The CO₂ capture apparatus 100 is, for example, a direct air capture apparatus that uses a separation membrane that selectively causes CO₂ to permeate therethrough. In the CO₂ capture apparatus 100, a second gas containing a higher concentration of carbon dioxide than the first gas does is separated, by the CO₂ separation unit 101 that uses a separation membrane module which selectively causes CO₂ to permeate therethrough, from a first gas and the separated second gas is extracted. The first gas here is not limited to the atmosphere and includes exhaust gas from factories, cars, etc. Gases other than CO₂ in the first gas pass through the CO₂ separation unit 101 and are discharged as passing gas.

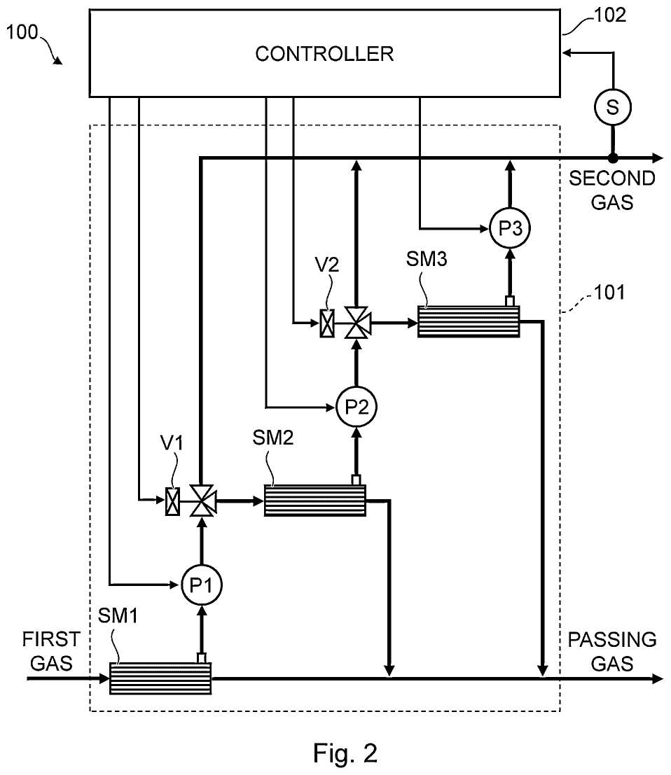

FIG. 2 is a block diagram showing a detailed configuration of one example of the CO₂ capture apparatus 100.

As shown in FIG. 2, the CO₂ separation unit 101 in the CO₂ capture apparatus 100 includes separation membrane modules SM1-SM3, suction pumps P1-P3, and three-way valves V1 and V2. The suction pumps P1-P3 and the three-way valves V1 and V2 are controlled, for example, by the controller 102. In FIG. 2, thick arrows indicate a flow of gas and thin arrows indicate a flow of a signal.

The separation membrane modules SM1-SM3 cause CO₂ to be selectively permeated therethrough by separation membranes. In each of the separation membrane modules SM1-SM3, for example, a number of hollow fiber separation membranes extending over both ends of a cylindrical container are bundled and this cylindrical container is filled with them.

As shown in FIG. 2, the first gas introduced from one end of the separation membrane module SM1 passes inside the separation membrane module SM1. The suction pump P1 is coupled to an outer peripheral surface in the other end part of the separation membrane module SM1. By the suction pump P1, CO₂ in the first gas that passes inside the separation membrane module SM1 is passed through the hollow fiber separation membranes, and is extracted to the outside of the separation membrane module SM1. The gas extracted from the separation membrane module SM1 contains a higher concentration of CO₂ than the first gas does. Gas from which CO₂ is removed is discharged from the other end of the separation membrane module SM1 as passing gas.

As shown in FIG. 2, the gas extracted from the separation membrane module SM1 can be directly supplied to the carbonate generation apparatus 200 via the three-way valve V1 as a second gas. On the other hand, the gas extracted from the separation membrane module SM1 can also be introduced into one end of the separation membrane module SM2 via the three-way valve V1. That is, the destination to which the gas extracted from the separation membrane module SM1 is supplied can be switched between the carbonate generation apparatus 200 and the separation membrane module SM2 by the three-way valve V1.

The suction pump P2 is coupled to the outer peripheral surface in the other end part of the separation membrane module SM2. By the suction pump P2, CO₂ in the gas that passes inside the separation membrane module SM2 is passed through the hollow fiber separation membranes, and is extracted to the outside of the separation membrane module SM2. The gas extracted from the separation membrane module SM2 contains a higher concentration of CO₂ than the gas extracted from the separation membrane module SM1 does. Gas from which CO₂ has been removed is discharged from the other end of the separation membrane module SM2 as passing gas.

As shown in FIG. 2, the gas extracted from the separation membrane module SM2 can be directly supplied to the carbonate generation apparatus 200 via the three-way valve V2 as a second gas. On the other hand, the gas extracted from the separation membrane module SM2 can also be introduced into one end of the separation membrane module SM3 via the three-way valve V2. That is, the destination to which the gas extracted from the separation membrane module SM2 is supplied can be switched between the carbonate generation apparatus 200 and the separation membrane module SM3 by the three-way valve V2.

The suction pump P3 is coupled to the outer peripheral surface in the other end part of the separation membrane module SM3. By the suction pump P3, CO₂ in the gas that passes inside the separation membrane module SM3 is passed through the hollow fiber separation membranes, and is extracted to the outside of the separation membrane module SM3. The gas extracted from the separation membrane module SM3 in the last stage is supplied to the carbonate generation apparatus 200 and contains a higher concentration of CO₂ than the gas extracted from the separation membrane module SM2 does. Gas from which CO₂ has been removed is discharged from the other end of the separation membrane module SM3 as passing gas.

As described above, in the CO₂ capture apparatus 100, the plurality of separation membrane modules SM1-SM3 are provided in such a way that they can be connected to each other in multiple stages. Then, by switching the number of connection stages of the separation membrane modules SM1-SM3, the concentration of CO₂ in the second gas can be changed. As described above, the greater the number of connection stages of the separation membrane modules SM1-SM3, the higher the concentration of CO₂ in the second gas, whereas the smaller the number of connection stages of the separation membrane modules SM1-SM3, the lower the concentration of CO₂ in the second gas.

As a matter of course, the number of separation membrane modules that can be connected to each other in multiple stages is not limited to three as shown in FIG. 2, and may be any number greater than one. As the number of separation membrane modules that can be connected to each other in multiple stages is greater, the concentration of CO₂ in the second gas can be controlled in a greater number of stages. As shown in FIG. 2, a suction pump is provided for each separation membrane module, and a three-way valve is provided between separation membrane modules adjacent to each other. Further, means for switching the destination to which the gas extracted from the separation membrane module is supplied is not limited to the three-way valve shown in FIG. 2, and may be composed of, for example, two open/close valves.

As shown in FIGS. 1 and 2, the controller 102 controls the CO₂ separation unit 101 based on the concentration of CO₂ in the second gas detected by the sensor S. More specifically, the controller 102 switches the number of connection stages of the separation membrane modules SM1-SM3 in such a way that the concentration of CO₂ in the second gas detected by the sensor S is maintained within a predetermined target concentration range.

When the concentration of CO₂ detected by the sensor S is lower than the predetermined target concentration range, it is possible that the reaction time when carbonate is generated in the carbonate generation apparatus 200 may be long. In this case, the controller 102 increases the number of connection stages of the separation membrane modules SM1-SM3 in such a way that the concentration of CO₂ in the second gas is increased.

On the other hand, when the concentration of CO₂ detected by the sensor S is higher than the predetermined target concentration range, it is possible that excessive CO₂ that does not react with alkaline earth compounds in the carbonate generation apparatus 200 may be released into the atmosphere again. In this case, the controller 102 decreases the number of connection stages of the separation membrane modules SM1-SM3 in such a way that the concentration of CO₂ in the second gas is decreased.

In the CO₂ capture apparatus 100 shown in FIG. 2, the controller 102 switches the number of connection stages of the separation membrane modules SM1-SM3 by controlling the three-way valves V1 and V2.

When, for example, the three-way valve V1 is switched so as to connect the separation membrane module SM2 to the separation membrane module SM1, the controller 102 further drives the suction pump P2 in addition to the suction pump P1.

Further, when the three-way valve V2 is switched so as to further connect the separation membrane module SM3 to the separation membrane module SM2 connected to the separation membrane module SM1, the controller 102 further drives the suction pump P3 in addition to the suction pumps P1 and P2.

According to the above-described configuration, in the CO₂ capture apparatus 100 shown in FIG. 2, the number of connection stages of the separation membrane modules SM1-SM3 can be switched among one to three.

Although not shown in FIG. 1, the controller 102 includes, for example, an arithmetic unit such as a Central Processing Unit (CPU), and a memory such as a Random Access Memory (RAM) or a Read Only Memory (ROM) that stores various programs, data, or the like. That is, the controller 102 includes a function as a computer, and performs various kinds of processing based on the various programs or the like described above.

The carbonate generation apparatus 200 into which the second gas extracted from the CO₂ capture apparatus 100 is introduced causes CO₂ in the second gas to be reacted with alkaline earth compounds to generate carbonate. The carbonate here is a carbonate of an alkaline earth metal and includes bicarbonate or a hydrate.

As the alkaline earth compound, an alkaline earth compound itself may be added. From the viewpoint of reducing environmental load, incinerated ash, slag, seawater or the like may be used. The incinerated ash or the like itself may be used, or incinerated ash or the like from which compounds that disturb CO₂ immobilization are removed in advance may be used. That is, incinerated ash or the like is not limited as long as CO₂ immobilization can be achieved, and may contain components other than the alkaline earth compounds.

The alkaline earth compound is a compound including an alkaline earth metal element, and is, for example, a hydrosoluble alkaline earth compound. Examples of the water-soluble alkaline earth compound may include alkaline earth metal oxides, alkaline earth metal nitrates, alkaline earth metal hydroxides, and a mixture thereof.

Suitable examples of the alkaline earth metal may include Be, Ca, Mg, Sr, Ba, Ra, or a combination thereof. Suitable examples of alkaline earth metal oxides may include CaO, MgO, SrO, BaO, or a combination thereof, suitable examples of alkaline earth metal nitrates may include Ca(NO₃)₂, Mg(NO₃)₂, Sr(NO₃)₂, Ba(NO₃)₂, or a combination thereof, and suitable examples of alkaline earth metal hydroxides may include Ca(OH)₂, Mg(OH)₂, Sr(OH)₂, Ba(OH)₂, or a combination thereof. Specific examples of carbonate may include CaCO₃, MgCO₃, SrCO₃, BaCO₃, or a combination thereof.

When water is used as a solvent and the incinerated ash contains calcium oxide, for example, carbonate ions are consumed by the following reactions, and thus the carbonate is generated.

CaO+H₂O→Ca²⁺+2OH⁻

CO₂+H₂O→2H⁺+CO₃²⁻

Ca²⁺+CO₃²⁻→CaCO₃

As shown in FIG. 1, the sensor S detects the concentration of CO₂ in the second gas. The sensor S is not particularly limited as long as it can detect the concentration of CO₂ in the gas, and is, for example, a CO₂ concentration meter, a CO₂ concentration analyzer or the like. The sensor S is not limited to the CO₂ concentration meter or the CO₂ concentration analyzer, and may be a sensor capable of indirectly detecting the concentration of CO₂ in the second gas.

The target concentration range of the CO₂ concentration is a concentration range where excessive CO₂ that does not react with the alkaline earth compounds can be reduced while reducing a rection time with the alkaline earth compounds. The target concentration range of the CO₂ concentration is determined as appropriate depending on the concentration or the like of the alkaline earth compounds in the carbonate generation apparatus 200 and can be changed as appropriate depending on the progress of the reaction with the alkaline earth compounds, or the like.

As described above, in the carbon dioxide immobilization system according to this embodiment, the number of connection stages of the separation membrane modules SM1-SM3 is switched in such a way that the concentration of CO₂ in the second gas extracted from the CO₂ capture apparatus 100 is maintained within a predetermined target concentration range. Therefore, when carbonate is generated and CO₂ is immobilized, the concentration of CO₂ in the second gas can be maintained within the predetermined target concentration range, and it is possible to prevent causing of an excessive amount of CO₂ while reducing the reaction time.

### <Carbon Dioxide Immobilization Method>

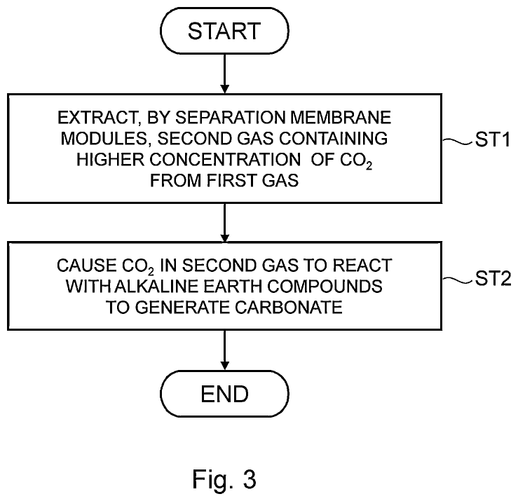

Next, with reference to FIG. 3, a carbon dioxide immobilization method according to the first embodiment will be described. FIG. 3 is a flowchart showing the carbon dioxide immobilization method according to the first embodiment. In the description of FIG. 3, FIGS. 1 and 2 are referred to as appropriate.

First, as shown in FIG. 3, a second gas containing a higher concentration of CO₂ than the first gas does is separated, by the separation membrane modules SM1-SM3 that selectively cause CO₂ to permeate therethrough, from a first gas and the separated second gas is extracted (Step ST1).

Then, as shown in FIG. 3, in the carbonate generation apparatus 200 shown in FIG. 1, CO₂ in the second gas is caused to react with alkaline earth compounds to generate carbonate (Step ST2).

In the carbon dioxide immobilization method according to this embodiment, in Step ST1, the CO₂ separation unit 101 is controlled based on the concentration of CO₂ in the second gas detected by the sensor S. More specifically, the controller 102 switches the number of connection stages of the separation membrane modules SM1-SM3 in such a way that the concentration of CO₂ in the second gas detected by the sensor S is maintained within a predetermined target concentration range.

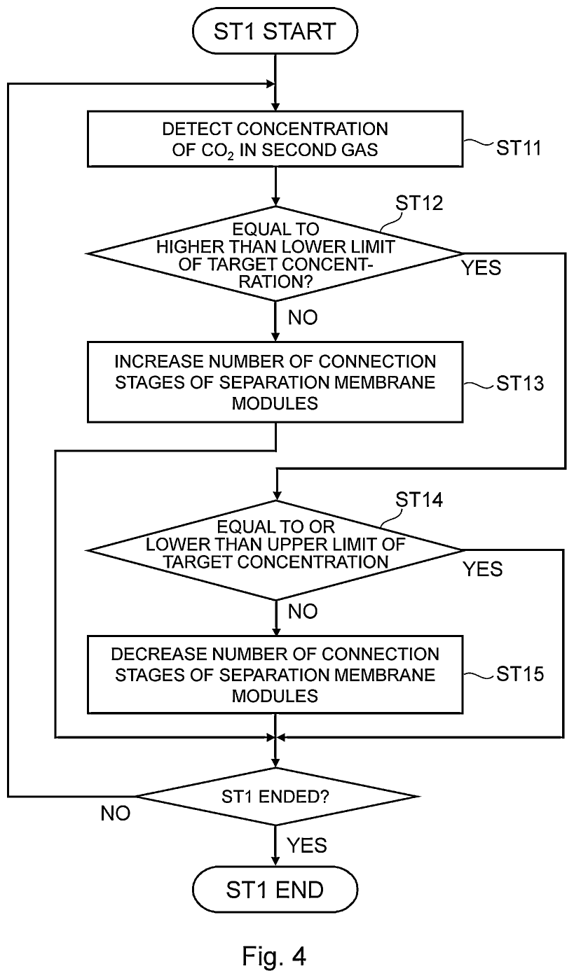

FIG. 4 is a flowchart showing a CO₂ concentration control method in the second gas in Step ST1 in FIG. 3.

First, as shown in FIG. 4, when Step ST1 is started, the concentration of CO₂ in the second gas is detected by the sensor S (Step ST11).

Next, the controller 102 determines whether or not the concentration of CO₂ detected by the sensor S is equal to or higher than a lower limit of the predetermined target concentration range (Step ST12). When the detected CO₂ concentration is lower than the lower limit of the target concentration range (NO in Step ST12), it is possible that the reaction time when carbonate is generated in the carbonate generation apparatus 200 may be long. Therefore, the controller 102 increases the number of connection stages of the separation membrane modules SM1-SM3 in such a way that the concentration of CO₂ in the second gas is increased (Step ST13). After that, when Step ST1 is not ended, the process returns to Step ST11.

On the other hand, when the detected CO₂ concentration is equal to or higher than the lower limit of the target concentration range (YES in Step ST12), the controller 102 determines whether or not the detected CO₂ concentration is equal to or lower than an upper limit of the predetermined target concentration range (Step ST14).

When the detected CO₂ concentration is higher than the upper limit of the predetermined target concentration range (NO in Step ST14), it is possible that excessive CO₂ that does not react with alkaline earth compounds in the carbonate generation apparatus 200 may be released into the atmosphere again. In this case, the controller 102 decreases the number of connection stages of the separation membrane modules SM1-SM3 in such a way that the concentration of CO₂ in the second gas is decreased (Step ST15). After that, if Step ST1 is not ended, the process returns to Step ST11.

When the detected CO₂ concentration is equal to or lower than the upper limit of the predetermined target concentration range (YES in Step ST14), if Step ST1 is not ended, the process simply returns to Step ST11.

As shown in FIG. 4, the controller 102 repeatedly performs processing of Steps ST11-ST15 described above from the start to the end of Step ST1.

The determination in Step ST12, and Step ST13 where the number of connection stages of separation membrane modules is increased are a set of steps. Further, the determination in Step ST14, and Step ST15 where the number of connection stages of separation membrane modules is decreased are a set of steps. While the determination in Step ST12 is performed first in FIG. 4 for the sake of convenience, the determination in Step ST14 may be performed first, or the determination in Step ST12 and that in Step ST14 may be performed at the same time.

As described above, in the carbon dioxide immobilization method according to this embodiment, the number of connection stages of the separation membrane modules SM1-SM3 is switched in such a way that the concentration of CO₂ in the second gas extracted in Step ST1 is maintained within a predetermined target concentration range. Therefore, when carbonate is generated and CO₂ is immobilized, the concentration of CO₂ in the second gas can be maintained within the predetermined target concentration range, and it is possible to prevent causing of an excessive amount of CO₂ while reducing the reaction time.

The present disclosure contributes to carbon neutral, decarbonization, and Sustainable Development Goals (SDGs).

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A carbon dioxide immobilization system comprising:
a carbon dioxide capture apparatus configured to separate, using a separation membrane module that selectively allows carbon dioxide to permeate therethrough, from a first gas a second gas containing a higher concentration of carbon dioxide than the first gas does and extract the separated second gas;
a carbonate generation apparatus configured to cause carbon dioxide in the second gas extracted from the carbon dioxide capture apparatus to be reacted with an alkaline earth compound to generate carbonate; and
a sensor configured to detect a concentration of carbon dioxide in the second gas, wherein
in the carbon dioxide capture apparatus, a plurality of the separation membrane modules are provided so as to be connected to each other in multiple stages, and
the number of connection stages of the separation membrane modules is switched in such a way that the concentration of carbon dioxide detected by the sensor is maintained within a predetermined target concentration range.

2. The carbon dioxide immobilization system according to claim 1, wherein the number of connection stages of the separation membrane modules is increased when the concentration of carbon dioxide detected by the sensor is lower than the predetermined target concentration range, and the number of connection stages of the separation membrane modules is decreased when the concentration of carbon dioxide detected by the sensor is higher than the predetermined target concentration range.

3. The carbon dioxide immobilization system according to claim 1, wherein the alkaline earth compound is included in incinerated ash, slag, or seawater.

4. A carbon dioxide immobilization method comprising:
separating, using a separation membrane module that selectively allows carbon dioxide to permeate therethrough, from a first gas a second gas containing a higher concentration of carbon dioxide than the first gas does and extracting the separated second gas; and
causing carbon dioxide in the extracted second gas to be reacted with an alkaline earth compound to generate carbonate, wherein
in the separation and extraction of the second gas,
a concentration of carbon dioxide in the extracted second gas is detected, and
the number of connection stages of the plurality of the separation membrane modules provided so as to be connected to each other in multiple stages is switched in such a way that the detected concentration of carbon dioxide is maintained within a predetermined target concentration range.

5. The carbon dioxide immobilization method according to claim 4, wherein the number of connection stages of the separation membrane modules is increased when the detected concentration of carbon dioxide is lower than the predetermined target concentration range, and the number of connection stages of the separation membrane modules is decreased when the detected concentration of carbon dioxide is higher than the predetermined target concentration range.

6. The carbon dioxide immobilization method according to claim 4, wherein the alkaline earth compound is included in incinerated ash, slag, or seawater.
